(19) United States
(12) Patent Application Publication
(10) Pub. No.: US 2025/0223305 A1
(43) Pub. Date: Jul. 10, 2025

(54) METAL-ORGANIC CAGES, METHODS OF MAKING, AND METHODS OF USE THEREOF

(71) Applicant: VIRGINIA TECH INTELLECTUAL PROPERTIES, INC., Blacksburg, VA (US)

(72) Inventors: Amanda Morris, Blacksburg, VA (US); Stefan Ilic, Chicago, IL (US); Ann Marie May, Chapel Hill, NC (US); Pavel Usov, Tokyo (JP)

(21) Appl. No.: 18/852,926

(22) PCT Filed: Mar. 31, 2023
(86) PCT No.: PCT/US2023/017208

§ 371 Date: Sep. 30, 2024

Related U.S. Application Data
(60) Provisional application No. 63/326,079, filed on Mar. 31, 2022.
(60) Provisional application No. 63/427,118, filed on Nov. 22, 2022.

(51) Int. Cl. C07F 5/06; C07F 7/00; C07F 7/28

(52) U.S. Cl. CPC C07F 5/069; C07F 7/003; C07F 7/28

(57) ABSTRACT

The disclosure relates to metal-organic cages which are a class of supramolecular structures comprising organic linkers and transition metal nodes. In an aspect an aluminum-based metal-organic cage (AI-pdc-AA) is disclosed. The cage formation was achieved via solvothermal self-assembly of an aluminum cluster and pyridine-dicarboxylic linker in the presence of acetic acid as a capping agent. The obtained supramolecular structure was characterized by single-crystal X-ray diffraction (SCXRD), thermbgravimetric analysis, and NMR spectroscopies. Based on the single crystal structure and computational analysis, the cage has a 3.7 A diameter electrophilic cavity suitable for the binding of cations, such as cesium (ionic radius 1.81 A). The host-guest interactions were probed with 1 H and 133Cs NM spectroscopies in DMSO, where at low concentrations Cs+ binds to AI-pdc-AA in a 1:1 ratio.

### CROSS-REFERENCE TO RELATED APPLICATIONS

This Application claims the benefit of U.S. Provisional Application No. 63/326,079, filed on Mar. 31, 2022, and U.S. Provisional Application No. 63/427,118, filed Nov. 22, 2022, both of which are incorporated herein by reference in their entireties.

### STATEMENT REGARDING FEDERALLY SPONSORED RESEARCH

This invention was made with government support under award DE-SC0012446 awarded by the United States Department of Energy. The government has certain rights in the invention.

### BACKGROUND

Metal-organic cages (MOCs), sometimes referred to as metal-organic polyhedra or coordination cages, are a class of porous supramolecular structures formed through the self-driven assembly of metal nodes and organic linkers in solution. The wide variety of employable metal nodes (i.e., single metal ions or metal clusters) and organic linkers (di-, tri, tetra-topic, etc.) enables a broad range of accessible MOC structures. The diversity of these materials is reflected in their topologies, pore sizes, functionality, and thermal and chemical stabilities. Consequently, this synthetic diversity enables the applicability of MOCs for different purposes. Since structural and chemical properties can be tuned through the judicious choice of starting material, there has been a growing interest in developing novel MOC architectures for numerous applications. For example, cages with large pores can serve as drug delivery vessels in biomedicine, chemical reactors in catalysis, or analyte receptors in biochemical sensing, whereas smaller cages can offer selectivity in small guest encapsulation, which can be useful in gas separation or extraction of chemical species from liquid media.

MOC syntheses often require strategic planning to prevent propagation into extended networks—metal-organic frameworks (MOFs). Several synthetic strategies have been developed to avoid this problem. Approaches that favor edge-capping, like directional binding or symmetry interactions, utilize carefully designed ligands with multiple well-oriented chelating groups that can satisfy all coordination sites on the metal. Furthermore, face-capping can be achieved by employing rigid planar linkers or by incorporation of an additional capping ligand, whose sole purpose is to block open coordination sites. Regardless of the approach, the preparation of MOCs frequently requires complicated syntheses of ligands that can accommodate capping. In addition, most studies utilize transition metal in their nodes, whereas only a few examples of MOCs composed of main group elements have been reported.

Recently, aluminum-based porous materials have been gaining attention due to several desirable properties. First, aluminum is the third most abundant element in the Earth's crust (8.3 wt %), providing a sustainable precursor for MOC synthesis. In addition, aluminum is cheap and lightweight which enables the scalability of aluminum materials and potential large-scale applications. Furthermore, the chemical properties of aluminum, such as its high positive charge on the metal ion and redox inertness, contribute to the stability of aluminum compounds. Finally, aluminum ions exhibit small ionic radii (i.e., Al³⁺ radius≈53 pm) and can thereby accommodate the formation of supramolecular structures with small pore sizes, a key property for many applications like chemical sensing and small guest encapsulation.

Based on these properties, it is not surprising that many aluminum-based MOF structures have been reported and applied in gas separation and chemical sensing. However, while aluminum is commonly employed in MOFs, it has not yet been employed in the preparation of MOC structures until now.

### SUMMARY

In accordance with the purpose(s) of the disclosure, as embodied and broadly described herein, the disclosure, in one aspect, relates an aluminum-based supramolecular structure prepared from inexpensive and commercially available starting materials.

In another aspect, a molecular cage hereinafter called “AI-pdc-AA, was prepared by solvothermal self-assembly from aluminum chloride hexahydrate and 2,5-pyridine-dicarboxylic acid linker in the presence of a capping agent, acetic acid.

In another aspect the AI-pdc-AA cage composition was elucidated using thermogravimetric analysis (TGA), NMR spectroscopy, and single-crystal X-ray diffraction (SCXRD); and pore accessibility was probed via host-guest chemistry in DMSO.

In another aspect, there is disclosed a cesium cation in association with AI-pdc-AA.

In another aspect, there is disclosed a composition comprising Cs+⊂AI-pdc-AA.

In another aspect, there is disclosed a rubidium cation in association with A-pdc-AA.

In another aspect, there is disclosed a method for capturing and/or isolating and/or extracting Cs⁺ ions, e.g., radioactive ¹³⁷Cs⁺ ions.

In another aspect, there is disclosed a device comprising AI-pdc-AA.

In another aspect, there is disclosed a method of protecting human health and/or animal health and/or the environment by poses a high risk to human health and the environment.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows structural characterization of the AI-pdc-AA cage crystal structure obtained from SCXRD according to the procedure described in the Examples; and dashed lines represent distances between indicated aluminum atoms.

FIG. 2 shows a comparison between the crystal structure from SCXRD (left) and DFT-optimized structure in DMSO (right) wherein the DFT optimization was performed using a B3LYP functional and LANL2DZ basis set for Al and 6-31 G* basis set for C, H, O and N.

FIG. 3A and FIG. 3B show comparative structural analyses obtained using pywindow on crystal and DFT-optimized structures in DMSO, respectively.

FIG. 4A, FIG. 4B, FIG. 4C, and FIG. 4D show cesium cation binding with the AI-pdc-AA cage. FIG. 4A shows ¹H NMR titrations of 0.1 mM AI-pdc-AA with CsClO₄. FIG. 4B shows ¹³³Cs NMR titrations of 10 mM CsClO₄ with AI-pdc-AA. FIG. 4C shows a crystal structure obtained from SCXRD for the Cs⁺⊂AI-pdc-AA complex. FIG. 4D shows binding isotherms used to determine binding constant whererin the fit was obtained using the BindFit v0.5 program.

FIG. 5A and FIG. 5B show size-selective host-guest interactions between AI-pdc-AA and alkali metal ions. FIG. 5A shows ¹H NMR spectra of AI-pdc-AA in the presence of alkali metal perchlorates (solvent DMSO-d6). FIG. 5B shows job plots for alkali ion binding by AI-pdc-AA obtained from NMR titrations.

FIG. 6 shows a graph of the thermal stability of AI-pdc-AA.

FIG. 7 shows ¹H-NMR spectra of AI-pdc-AA.

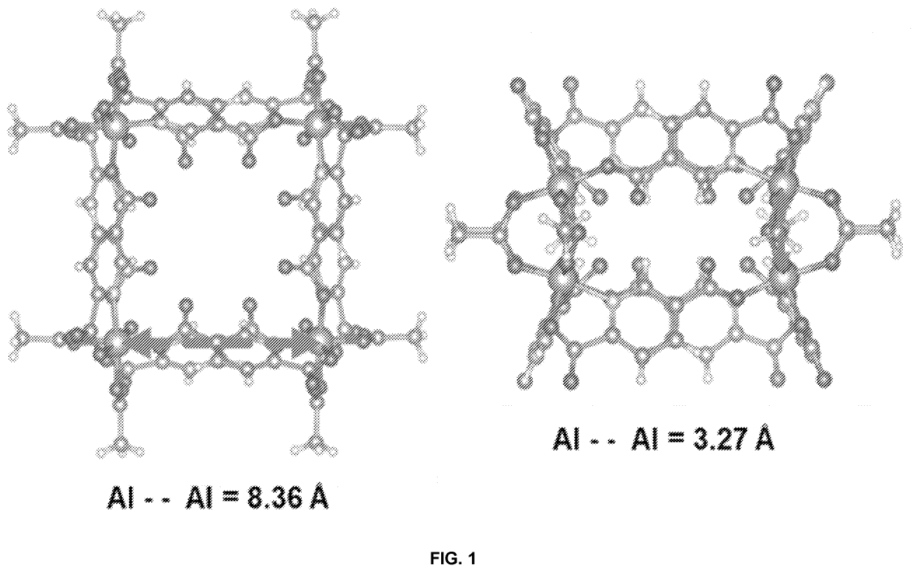

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. about x, y, z, or less' and should be interpreted to include the specific ranges of ‘about x’, ‘about y’, and ‘about z’ as well as the ranges of ‘less than x’, ‘less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

The disclosure includes a metal-organic cage comprising a plurality of metal sites connected via a plurality of organic ligands to form a channel-like intramolecular void in the center; wherein each of the metal sites comprises a main group metal. The void can be defined dimensionally as cuboid, having a height, width, and length. In an embodiment, defining atoms of the void are metal atoms, e.g., aluminum atoms, wherein the height is from about 3 to 4 angstroms, the width is about 7 to 9 angstroms, and the length is about 7 to 9 angstroms.

In an aspect, the metal cage main group metal is aluminum, titanium, and/or zirconium, preferably aluminum. The cage is prepared by admixing and dissolving a salt of a main group metal, e.g., aluminum, for example an aluminum halide, aluminum sulfate, or aluminum nitrate, an organic ligand, and an organic acid in a solvent to form a mixture; and
(b) reacting the mixture for a period of time at an elevated temperature relative to room temperature;
(c) cooling or allowing the heated mixture to cool, wherein upon cooling the metal-organic cage is formed.

Typically, the main group metal may be aluminum halide may be a fluoride, chloride, and or bromide anion.

The period of time may be selected as needed by the person of ordinary skill in the art, and may comprise minutes, hours or days. For example, the period of time may be about about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about or 96 hours. In the forgoing list of hours, the period of time may fall in a range of numbers from one number to another. For example, the number of hours may be from about 22 to about 32.

The elevated temperature may be selected as needed by the person of ordinary skill in the art. For example, the elevated temperature may be about 60° C., about 70° C., about 80° C., about 90° C. about 100° C., about 110° C., about 120° C., about 130° C., about 140° C., about 150° C., about 160° C., about 170° C., about 180° C., about 190, about 200° C., about 210° C., about 220° C., about 230° C., about 240° C., or about 250° C. In the forgoing list of temperatures, the elevated temperature may fall in a range of numbers from one number to another. For example, the temperature may be from about 80° C. to about 130° C.

The pressure of the reaction may be selected as needed by a person of ordinary skill in the art. For example, the reaction may be effected at about 0.5, about 0.6, about 0.7, about 0.8, about 0.9, about 1.0, about 1.1, about 1.2, about 1.3, about 1.4, about 1.5, about 1.6, about 1.7, about 1.8, about 1.9 or about 2.0 atmospheres. In the forgoing list of pressures, the pressure may fall in a range of numbers from one number to another. For example, the pressure may be from about 0.9 atm to about 1.6 atm.

The organic ligand may be bidentate, tridentate, or tetradentate. The ligand may be a compound of formula I

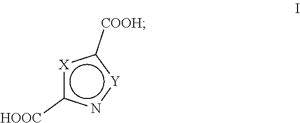

wherein X is —C(H)═N—, —C(H)═C(H)—, oxygen, or sulfur;
wherein Y is C—H or N;
or a salt thereof.

In an aspect, X is —C(H)═C(H)—, and Y is C—H.

In an aspect, X is —C(H)═N— and Y is C—H.

In an aspect, X is S and Y is CH

In an aspect, X is S and Y is N.

In an aspect the organic ligand is selected from group consisting of

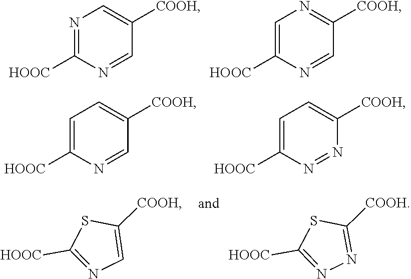

The organic ligand may also be a salt of a compound of formula (I). The salt may be monocarboxylic acid salt, or a dicarboxylic acid salt.

In an aspect, the organic ligand is the compound:

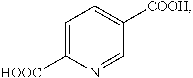 [SMILES: O=C(O)c1ccc(C(=O)O)nc1]

or a salt thereof.

In an embodiment, the molecular cage may be used to extract a cesium or rubidium ion from an aqueous environment. In an embodiment, an amount of the metal-organic cage may be placed inside a vessel where the cesium or rubidium ions are present in an aqueous composition; after a period chosen by the person of ordinary skill, the aqueous composition is removed and the metal organic cage and cesium ion or rubidium ion complex is flushed with acid, base, or binding agent to remove the cesium or rubidium ions.

In a similar embodiment, the molecular cage may be embedded or distributed within a solid-state matrix, or kit, which is then exposed to or contacted with an aqueous composition comprising a cesium or rubidium cation.

The solid-state matrix may be one that is susceptible to penetration by an aqueous composition. For example, in a non-limiting, representative embodiment, the molecular cage may be incorporated into a floral foam, e.g., according to the method of U.S. Pat. No. 4,225,679 (incorporated by reference herein). For example, the method of producing the foamed product with incorporate molecular cage can be accomplished by selecting a phenolic resin of low viscosity in the range of, for example, 1000 to 2000 centipoise at ambient or room temperature and blowing pentane through the foam to cause the desired expansion and setting.

### Resin Formulation Components (Percent Composition)

Phenolformaldehyde Resin (75-95)
Optional Surfactant (3-5)
Optional Wetting Agent (3-5)
Pentane (blowing agent) 4-5
Urea
Molecular Cage particles (0.1-5)
Phenol Sulfonic Acid Catalyst (4-5)
Bacteriocide (0.1)
Balance to 100%

### Aspects

The following listing of exemplary aspects supports and is supported by the disclosure provided herein.

Aspect 1. A metal-organic cage comprising a plurality of metal sites connected via a plurality of organic ligands to form a channel-like intramolecular void in the center; wherein each of the metal sites comprises a main group metal.

Aspect 2. A metal-organic cage having a structure according to the following formula M₄L₈; wherein each occurrence of M is a metal site comprising one or more main group metals; and wherein each occurrence of L is an organic ligand bridging two or more of the metal sites to form a channel-like intramolecular void.

Aspect 3. A metal-organic cage made by a method according to aspect 1 or aspect 2.

Aspect 4. A method of making a metal-organic cage, the method comprising
(a) dissolving a salt of a main group metal, for example a halide, a sulfate, or a nitrate, of a main group metal, an organic ligand, and an organic acid in a solvent to form a mixture; and
(b) reacting the mixture for a period of time at an elevated temperature relative to room temperature;
(c) cooling or allowing the heated mixture to cool, wherein upon cooling the metal-organic cage is formed.

Aspect 5. The method of aspect 4 wherein the solvent is selected from N,N-dimethyl acetamide (DMAC), dimethyl sulfoxide (DMSO), N,N-dimethylformamide (DMF), N-methylpyrolidone (NMP), N,N-diethylformamide (DEF) and mixtures thereof.

Aspect 6. The method of aspect 4 or aspect 5 wherein the period of time is from about 5, about 10, or about 15 hours and up to about 24, about 36, or about 48 hours.

Aspect 7. The method of any one of the foregoing aspects, wherein the elevated temperature is from about 100° C., about 110° C., about 120° C. and up to about 130° C., 140° C., or 150° C.

Aspect 8. The metal-organic cage of any one of the foregoing aspects, or wherein each occurrence of the organic ligand is independently selected from the group consisting of a di-topic ligand, a tri-topic ligand, a tetra-topic ligand, and a combination thereof.

Aspect 9. The metal-organic cage of any one of the foregoing aspects, wherein each occurrence of the organic ligand has a structure according to any one of the following formulas:

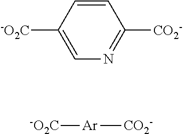

wherein Ar is an aromatic heterocycle having at least one N or O atom capable of non-covalently binding to a metal site.

Aspect 10. The metal-organic cage of any one of the foregoing aspects, wherein the main group metal is selected from the group consisting of sodium, potassium, magnesium, calcium, aluminum, gallium, and a combination thereof.

Aspect 11. The metal-organic cage of any one of the foregoing aspects, wherein each metal site comprises a two or more main group metal atoms bridged by one or more oxo or hydroxo ligands and having one or more capping ligands; and wherein each of the capping ligands comprises a conjugate base of an organic acid; and wherein each metal site has a net positive charge.

Aspect 12. The metal-organic cage of any one of the foregoing aspects, wherein each metal site independently has a structure according to formula mₓ(μ-OH)_{y}(AcO)_{z} wherein m is a main group metal having a positive charge of +a, where a is an integer from 1 to 3; where x, y, and z are non-negative integers; and wherein ax-y-z=an integer 1, 2, or 3.

Aspect 13. A self-assembled molecular cage comprising a first whole number of 6-coordinate metal atoms and a second whole number of a tridentate ligands, which self-assembled molecular cage defines a metal ion chelation volume; wherein the 6-coordinate metal atom is selected from the group consisting of aluminum, titanium, and zirconium; wherein the ligand is a compound of formula I:

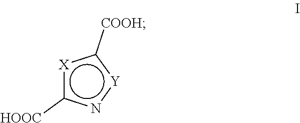

wherein X is —C(H)═N—, —C(H)═C(H)—, oxygen, or sulfur;
wherein Y is C—H or N,
or a salt thereof.

Aspect 14. The self-assembled molecular cage of any one of the foregoing aspects, wherein the metal is aluminum.

Aspect 15. The self-assembled molecular cage of any one of the foregoing aspects, wherein the ratio of the first whole number to the second whole number is 8:12.

Aspect 16. The self-assembled molecular cage of any one of the foregoing aspects, wherein the metal is titanium.

Aspect 17. The self-assembled molecular cage of any one of the foregoing aspects, wherein the metal is zirconium.

Aspect 18. The self-assembled molecular cage of any one of the foregoing aspects, comprising a third number of a carboxylic acids and/or anions thereof which acids and/or anions coordinate with one or more of the 6-coordinate metal atoms.

Aspect 19. The self-assembled molecular cage of any one of the foregoing aspects, wherein X is a C═C bond.

Aspect 20. The self-assembled molecular cage of any one of the foregoing aspects, wherein X is a sulfur atom.

Aspect 21. The self-assembled molecular cage of any one of the foregoing aspects, wherein X is a C═N.

Aspect 22. The self-assembled molecular cage of any one of the foregoing aspects, wherein Y is C—H.

Aspect 23. The self-assembled molecular cage of any one of the foregoing aspects, wherein Y is N.

Aspect 24. The self-assembled molecular cage of any one of the foregoing aspects, wherein the compound of formula I is selected from the group consisting of:

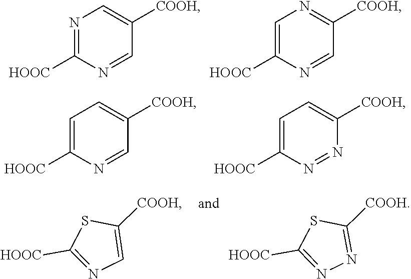

Aspect 25. The self-assembled molecular cage of any one of the foregoing aspects, wherein the metal ion is Cs+ or Rb+.

Aspect 26. The self-assembled molecular cage of any one of the foregoing aspects, wherein the metal ion is Cs⁺.

Aspect 27. The self-assembled molecular cage of any one of the foregoing aspects, wherein the carboxylic acid or anion thereof is a C₁-C₆ alkanoic acid or anion thereof.

Aspect 28. The self-assembled molecular cage of any one of the foregoing aspects, wherein the carboxylic acid or anion thereof is a C₁-C₃ alkanoic acid or anion thereof.

Aspect 29. The self-assembled molecular cage of any one of the foregoing aspects, wherein the carboxylic acid or anion thereof is acetic acid or an acetate anion.

Aspect 30. The self-assembled molecular cage of any one of the foregoing aspects, wherein the compound of formula I is

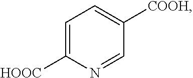 [SMILES: O=C(O)c1ccc(C(=O)O)nc1]

or a salt thereof.

Aspect 31. The self-assembled molecular cage of any one of the foregoing aspects, wherein the ratio of nitrogen atoms to aluminum atoms is 1:1.

Aspect 32. The self-assembled molecular cage of any one of the foregoing aspects, wherein the ratio of nitrogen atoms to aluminum atoms is 2:1.

Aspect 33. The self-assembled molecular cage of any one of the foregoing aspects, wherein the molecular formula of the cage is about C₇₂H₄₈Al₈N₈O₅₂ as determined from single crystal X-ray diffraction of a cell unit C₇₂H₄₈Al₈N₈O₅₂·11[C₃H₇NO] wherein C₃H₇NO is the empirical formula of N,N-dimethylformamide, and excluding any charge balancing H-atoms.

Aspect 34. A self-assembled molecular cage of any one of the foregoing aspects, wherein the molecular formula of the cage is about C₇₂H₄₈Al₈N₈O₅₂ as determined from single crystal X-ray diffraction of a cell unit C₇₂H₄₈Al₈N₈O₅₂·11[C₃H₇NO] associated with a cesium cation or a rubidium cation, and excluding any charge balancing H-atoms.

Aspect 35. A self-assembled molecular cage of any one of the foregoing aspects, wherein the cage chelates a cesium cation or rubidium cation wherein the molecular formula of the cage is about C₇₂H₄₈Al₈N₈O₅₂ as determined from single crystal X-ray diffraction of a cell unit Cs⊂C₇₂H₄₈Al₈N₈O₅₂·11.5[C₃H₇NO] wherein C₃H₇NO is the empirical formula of N,N-dimethylformamide, and excluding any charge balancing H-atoms.

Aspect 36. A method of preparing a self-assembled molecular cage of any one of the foregoing aspects, comprising admixing equimolar amounts of a 6-coordinate metal cation, wherein the metal is selected from the group consisting of aluminum, titanium, and zirconium, the compound of formula I, and at least a molar excess of the carboxylic acid in a polar aprotic solvent.

Aspect 37. The method of any one of the foregoing aspects, further wherein the method is carried out at a temperature greater than ambient temperature at 1 atm pressure.

Aspect 38. The method of any one of the foregoing aspects, wherein the method is carried out at a temperature of from 80° C. to about 160° C.

Aspect 39. The method of any one of the foregoing aspects, wherein the method is carried out at a temperature of from 100° C. to about 140° C.

Aspect 40. The method of any one of the foregoing aspects, wherein the method is carried out at a temperature of from 110° C. to about 130° C.

Aspect 41. The method of any one of the foregoing aspects, wherein the method is carried out at a pressure greater than 1 atm.

Aspect 42. The method of any one of the foregoing aspects, wherein the method is carried out at a pressure of from 1 atm to about 2 atm.

Aspect 43. The method of any one of the foregoing aspects, wherein the metal cation is admixed as a salt wherein an anionic counterion to the metal cation is selected from the group consisting of a halide, nitrate, nitrite, sulfate, phosphate, carbonate, acetate, formate, and cyanide.

Aspect 44. A a solid-state matrix comprising the molecular cage of any one of the foregoing aspects.

Aspect 45. A kit comprising the molecular cage of any one of the foregoing aspects, or the solid-state matrix of aspect 44.

Aspect 46. A method of extracting cesium or rubidium cations from a liquid composition comprising contacting the molecular cage, solid state matrix, or kit of any one of the foregoing aspects.

Aspect 47. The method of aspect 46 wherein the composition is an aqueous liquid composition.

Aspect 48. The method of aspect 47 wherein the aqueous liquid composition is removed after contacting the molecular cage, the solid-state matrix, or kit.

Aspect 49. The method of aspect 48 wherein the molecular cage is washed with a cesium cation or rubidium cation binding agent wherein the binding agent is sufficient to extract the cesium cation or rubidium cation from the molecular cage.

Aspect 50. The method of aspect 46 wherein the cesium cation is a radioactive cesium cation.

Aspect 51. The method of aspect 50 wherein the cesium cation is ¹³⁷Ce⁺.

Aspect 52. The molecular cage of any one of the foregoing aspects wherein the cage chelates a cesium cation with a binding constant of about 4500±100 to about 5500±100, or from about 4800±100 to about 5200±100, or about 5000±100.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The following examples are put forth to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

General Methods. All chemicals and solvents were purchased from the commercial sources and used without further purification, unless otherwise noted.

Preparation of AI-pdc-AA. With reference to Scheme 1, below, in a 6-dram scintillation vial, 313.2 mg of AlCl₃·6H₂O (1.3 mmol, 1 eq) and 217.3 mg of pyridine-2,5-dicarboxylic acid (1.3 mmol, 1 eq) were dissolved in 10 mL of N,N-dimethyl formamide (DMF) via sonication, followed by the addition of 3.75 mL of glacial acetic acid (65.5 mmol, 50 eq). The vial was sealed and then heated at 120° C. for 24 hours; and it was subsequently cooled to room temperature. After 3 days, a white precipitate was isolated via vacuum filtration, followed by washing with fresh DMF and dichloromethane, and then soaked in fresh dichloromethane overnight. The obtained precipitate was then vacuum dried at 60° C. overnight to provide 170.9 mg of the desired product.

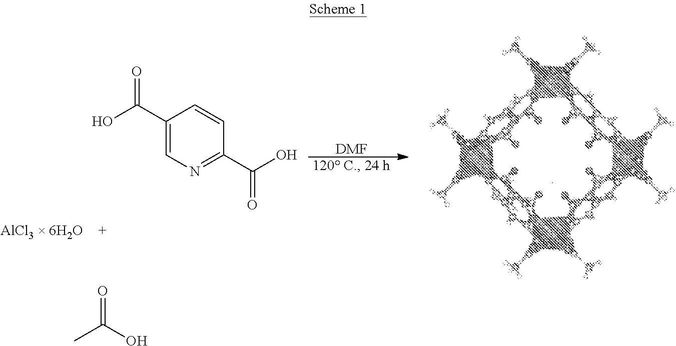

Single Crystal Preparation. In a 1-dram scintillation vial, 12.5 mg of AlCl₃·6H₂O (52 mmol, 1 eq) and 8.7 mg of pyridine-2,5-dicarboxylic acid (52 mmol, 1 eq) were dissolved in 3.87 mL DMF and 0.13 mL glacial acetic acid (2.3 mmol, 45 eq). The vial was then heated at 120° C. for 24 hours and subsequently cooled to room temperature. Needle-like crystals appeared after 3 weeks. Single crystals for the AI-pdc-AA: Cs+ complex were prepared using the same procedure, but in the presence of 30 mg of CSClO₄ (20 eq).

Powder X-ray Diffraction. A 600 W Rigaku MiniFlex powder diffractometer with a Cu Kα (0.15418 nm) radiation source was used, with a sweeping range of 5-30° in a continuous scanning mode. Powder X-ray diffraction (PXRD) traces were collected in 0.050 increments at a scanning rate of 0.5°/min, using a zero-background Si (510) plate.

Thermogravimetric Analysis (TGA). TGA was used to determine the thermal stability of the AI-pdc-AA powder. To remove residual solvent, the powders were dried under vacuum at 120° C. overnight. TGA measurements were performed with ˜10 mg samples using a Q500 thermal analyzer (TA Instruments, New Castle, DE, United States) by heating from room temperature to 800° C. at 10° C./min under oxygen.

NMR Experiments. ¹H, 2D ¹H-¹H COSY, 2D ¹H-¹³C HSQC, and 2D ¹H-¹³C HMBC NMR spectra were recorded on an Agilent U4-DD2 spectrometer at 400 MHz for ¹H and 100 MHz for ¹³C. ¹³³Cs NMR spectra were acquired on a Bruker Avance III spectrometer at 78.67 MHz. Samples were analyzed as solutions in DMSO-d6 at 25° C. in standard 5 mm o.d. tubes for 1D and 2D ¹H and ¹³C NMR experiments. For ¹³³Cs NMR experiments, 5 mm o.d. thin wall tubes were employed with coaxial inserts containing an internal standard solution of CsClO₄ in D₂O.

Single-Crystal X-Ray Diffraction (SCXRD). Single crystal X-ray diffraction was collected on a Rigaku Oxford Diffraction Synergy-S, equipped with a HyPix6000HE detector with CuKα radiation. A full description of the experimental details for data collection and analysis can be found in Supplemental Information.

DFT Optimization and Structure Analysis. The calculations were performed in Gaussian 16 using the B3LYP functional. The LANL2DZ basis set and pseudopotential was used for the Al atoms, and the 6-31G* basis set was used for the remaining atoms. A Polarizable Continuum Model (PCM) was used to incorporate the influence of solvent (DMSO). The structural analysis, including the average cage diameter, pore diameter and volume, and number of accessible windows, was performed using pywindow.

Binding Constant Calculations. Molar ratios used for the construction of binding isotherm were obtained from ¹H and ¹³³Cs NMR titrations. The isotherms were fitted using the Bindfit v0.5 program available at http://supramolecular.org.

### Results and Discussion

Synthesis and Single Crystal X-ray Diffraction Characterization. The aluminum cage, AI-pdc-AA, was prepared via solvothermal synthesis. As shown in Scheme 1, aluminum chloride hexahydrate (1 eq), 2,5-pyridinedicarboxylic acid linker (pdc, 1 eq) and glacial acetic acid (50 eq) were dissolved in DMF solvent and reacted at 120° C. for 24 h (Scheme 1).

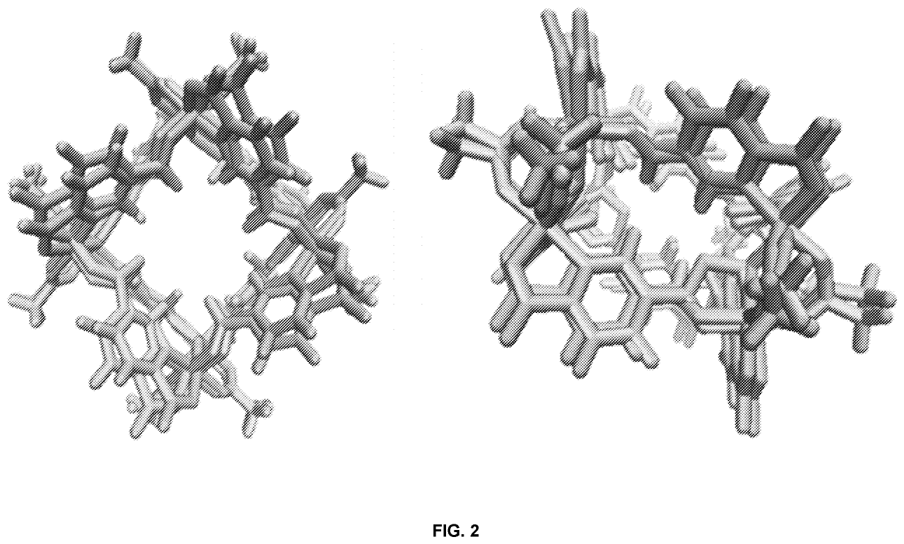

Crystals suitable for structure determination were obtained by lowering the starting material concentration during solvothermal synthesis. The crystallographic details are summarized in Table 1. The AI-pdc-AA cage crystalizes in the tetragonal space group P4/ncc with unit cell lengths a=25.2797(5) Å, c=22.6137(12) Å and molecular formula, [Al₂(μ-OH)(AcO)₂]₄(pdc)₈. The cage belongs to the D₄ point group and has a channel-like intramolecular void in the center (FIG. 2, panel a)). In the structure, four dinuclear aluminum clusters are connected via eight tritopic pdc linkers to form a charge-neutral supramolecular cage, as evidenced by the lack of counterions within the structure. Each aluminum atom within the cluster is bridged by two capping acetates and a bridging oxo (or hydroxo) ligand. Due to disorder within the structure, assignment of the bridging oxygen species to an oxo or hydroxo species is difficult and thereby requires additional evidence for concrete assignment, as other ligands in the structure (i.e., carbonyls from the acetate or pdc ligands) may serve as protonation sites to promote charge neutrality.

TABLE 1

| | AI-pdc-AA | Cs⁺⊂AI-pdc-AA |
|---|---|---|
| Space group | P4/ncc | P4/ncc |
| a (Å) | 25.2797(5) | 25.3579(3) |
| c (Å) | 22.6137(12) | 22.2143(11) |
| V (Å³) | 14451.5(9) | 14284.3(7) |
| temperature (K) | 100 | 100 |
| Wavelength (Å) | 1.5406 | 1.5406 |
| 2θ range (°) | 4.2590-59.5400 | 3.4470-72.8970 |
| Goodness of fit | 0.913 | 1.099 |
| R₁ | 0.0827 | 0.0789 |
| wR₂ | 0.2786 | 0.2606 |

The crystallographic structure revealed that coordination of pdcto Al proceeded through an interesting triptopic linker connectivity, where the linker chelates a single aluminum atom via a pyridinic nitrogen and proximal carboxylate oxygen. The distal carboxylate coordinates via a monodentate carboxylate binding mode to another aluminum cluster, forming one edge of the MOC. This unique connectivity orients one oxygen from each pdc carboxylate into the MOC cavity. Therefore, these inward-facing carbonyl oxygen atoms (FIG. 2, panels a) and b)) form a cavity with properties unorthodox to the MOC materials. In general, MOC cavities tend to be either hydrophobic or nucleophilic and serve as hosts for the sensing of gases and organic molecules or anions, respectively. In the case of AI-pdc-AA, carboxylate oxygens create an electrophilic environment reminiscent of other organic host systems (e.g. crown ethers, cryptophanes, and calixarenes). Therefore, we proposed the electrophilic cavity environment could facilitate binding of cations, a feature rarely observed with MOC materials, and unlock a novel MOC application for cation binding.

Based on these properties and considering the void space within this supramolecular cage, Cs⁺ cations were targeted due to their large ionic radius (1.81 Å) which should allow considerable stabilizing interactions with the carbonyl ligands and promote cation binding. Furthermore, ¹³⁷Cs⁺ is a major radioactive by-product within nuclear waste streams and the high aqueous solubility of its salts enables detrimental bioaccumulation in living organisms upon environmental release. Therefore, we proposed that implementing this material could enable selective extraction routes to prevent its harm to human health and the environment. To test this hypothesis, Cs⁺ (20 eq) was added to the synthesis of AI-pdc-AA at dilute concentrations (comparable to AI-pdc-AA crystallization conditions, see Experimental section for details). Under these conditions, the direct crystallization of Cs⁺⊂AI-pdc-AA was accomplished. Like the parent structure of AI-pdc-AA, the Cs⁺⊂AI-pdc-AA complex crystalizes in the tetragonal space group P4/ncc with unit cell lengths a=25.3579(3) Å and c=22.2143(11) Å. The obtained crystal structure reveals that Cs⁺ coordinates to the eight carbonyl oxygens within the electrophilic cavity and suggests a 1:1 binding ratio at low concentrations. The AI-pdc-AA undergoes a mild contraction upon cesium encapsulation, wherein the c axis shortens by 0.4 Å, respectively. Analogous structural contractions have been previously observed for other host-guest systems, consistent with ion binding.

The successful crystallization of Cs⁺ within AI-pdc-AA revealed the viability of AI-pdc-AA to facilitate large cation binding. To further probe this application, the bulk, as-synthesized powder was characterized for its ability to incorporate Cs⁺ into its structure post-synthetically. First, the bulk powder was characterized by several methods to confirm that the bulk material matched the identity of the single crystalline material. PXRD traces of the as-synthesized powder exhibit high intensity peaks at low angles 2Θ=5, 10 and 12, which are distinct from the PXRD pattern of starting materials, yet the powder exhibits poor crystallinity as evidenced by a broad amorphous background. However, when synthesized at lower concentrations, the material exhibits enhanced crystallinity and matches well with the pattern predicted from the SCXRD, further supporting these structural assignments.

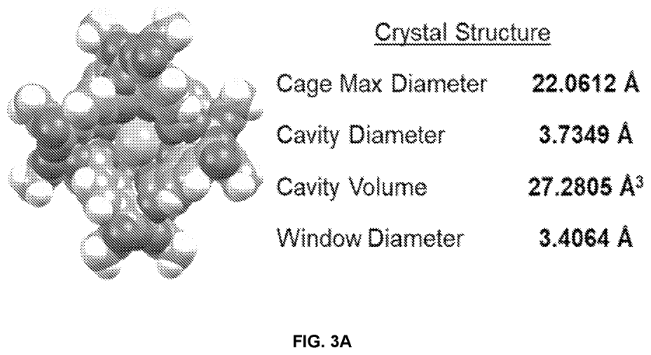

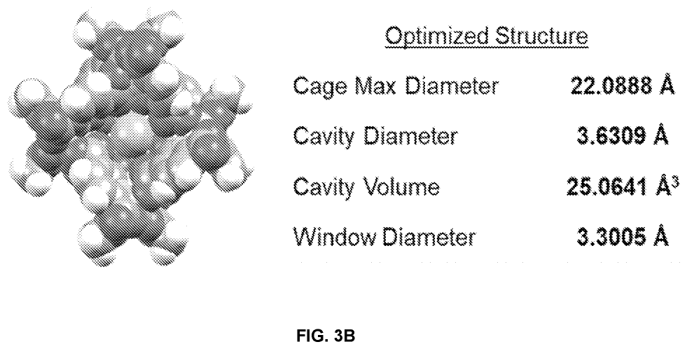

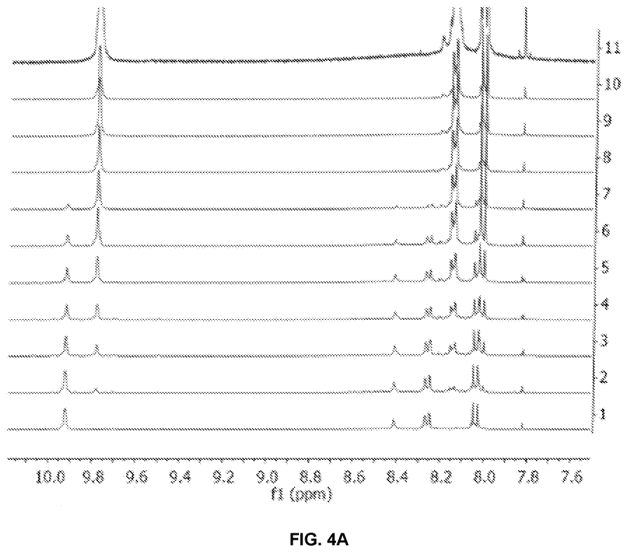

The thermal stability of the AI-pdc-AA powder was determined using TGA under nitrogen and further confirms the identity of the bulk material (FIG. 3, panel a)). The initial weight loss in mass<100° C. is assigned to the removal of the solvent used for washing of the powder (DCM). In the temperature range between 10° and 350° C., a weight loss of ˜18% is observed, which has been previously assigned to the acetate loss in similar supramolecular systems. At temperatures>400° C., the organic linker pdc (˜55% weight) thermally decomposes, leaving behind presumably Al₂O₃. The ratio of pdc to acetate incorporated into the cage is approximately 1:1, based on their respective % weight losses and is consistent with the proposed structure.

Lastly, the bulk powder was characterized via NMR spectroscopy. ¹H NMR spectra of AI-pdc-AA in DMSO-d₆ show three aromatic resonances (i.e., a singlet at 9.92 ppm and two doublets centered at 8.26 ppm and 8.04 ppm, respectively) corresponding to a deprotonated pdc linker and a singlet is observed in the aliphatic region (1.78 ppm) corresponding to the bridging acetate (FIG. 3, Panel b)). These peaks exhibit distinct chemical shifts compared to their starting materials, pdc and acetic acid, indicating successful ligand metalation. Furthermore, their relative integrations support a 1:1 ratio of pdc linker to acetate. However, two additional singlet resonances are observed in thiFIGs spectrum at 8.41 ppm and 2.62 ppm, suggesting additional chemical species are present.

To further probe the identity of these features, 2D NMR techniques were employed, including 2D ¹H-¹H COSY, 2D ¹H-¹³C HSQC, and 2D ¹H-¹³C HMBC. The unknown resonance at 8.26 ppm lacks coupling to both ¹H and ¹³CH resonances in ¹H-¹H COSY and ¹H-¹³C HSQC spectra, suggesting a protonated oxygen moiety. In addition, ¹H-¹³C HMBC cross peaks were absent for this resonance, suggesting a bridging hydroxo ligand within each aluminum cluster, consistent with its relative integration to the pdc and acetate ligands. Conversely, this peak could be attributed to a protonated carboxylate ligand, yet this is less likely as an HMBC cross peak would be anticipated due to the proximity of this proposed protonation site to a neighboring carbon (i.e., two bonds away). Like the first peak, the second resonance at 1.78 ppm does not exhibit cross peaks in ¹H-¹H COSY and ¹H-¹³C HSQC spectra. However, this peak does exhibit coupling with a ¹³C peak at 34.82 ppm within its ¹H-¹³C HMBC spectrum. The broadness of this peak also suggests the species is in fast exchange on the NMR timescale. These characteristics suggest that this peak is likely DMSO-encapsulated within the cage and likely accounts for the disorder observed within the crystal structure. Despite these assignments, we were unable to fully account for each of the protonation sites as four additional protonation sites are required to support charge neutrality. These protons are likely located on the free carboxylate oxygens and in rapid exchange with solvent, accounting for the absence of its NMR resonance. Despite this limitation, this characterization confirms the chemical integrity of the material and enables further investigation into its practical applications: cation binding.

Cesium Binding. Due to the high solubility of cesium salts in aqueous media, identifying materials that can effectively extract these cations is important for nuclear wastewater treatment. Advantageously, AI-pdc-AA exhibits poor solubility in water, among other solvents such as DMF, methanol, ethanol, and acetonitrile. Therefore, AI-pdc-AA could serve as an inexpensively sourced material for the solid-state extraction of cesium from wastewater. However, the characterization of host-guest interactions in heterogenous mixtures can be challenging and is more readily achieved in solution-based systems, where the concentration of each species can be experimentally measured. Therefore, the moderate solubility of AI-pdc-AA in DMSO was exploited, such that the ¹H and ¹³³Cs NMR spectroscopy could be employed to study the host-guest binding properties of this material.

Prior to these titrations, a geometry optimization of AI-pdc-AA was conducted using DFT. As shown in FIG. 2, panel b, the DFT-optimized structure shows minimal structural alterations between the solid and solution phase. In addition, structural parameters important for the host-guest chemistry, such as cavity volume and window diameter, were computed with pywindow. Comparison of this cavity volume to that determined by SCXRD suggests the porosity of this material in solution is analogous to that of its solid state and therefore solution-based studies should serve as an appropriate proxy for solid-state binding.

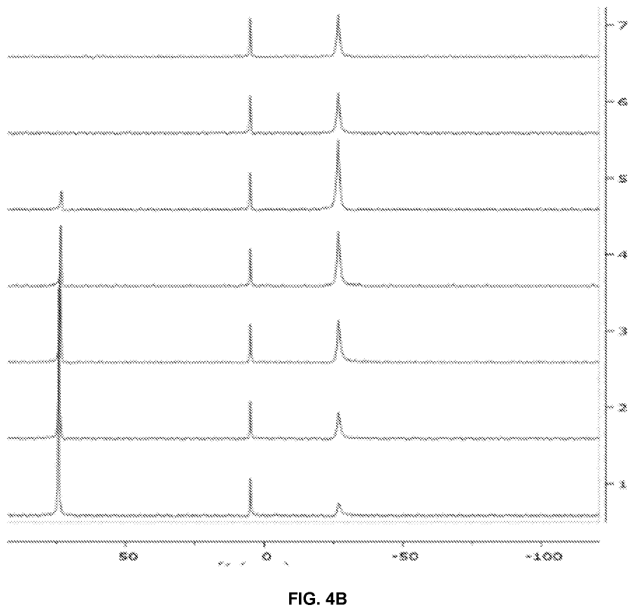

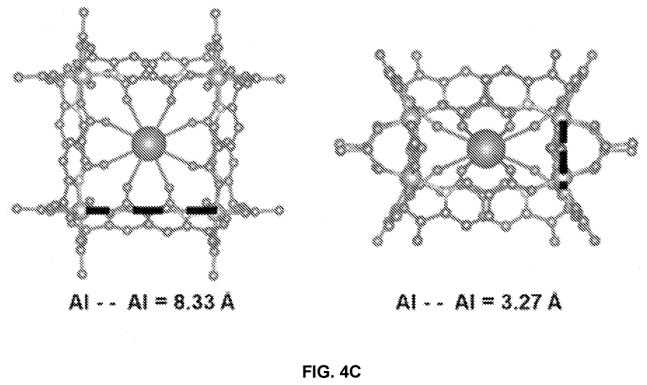

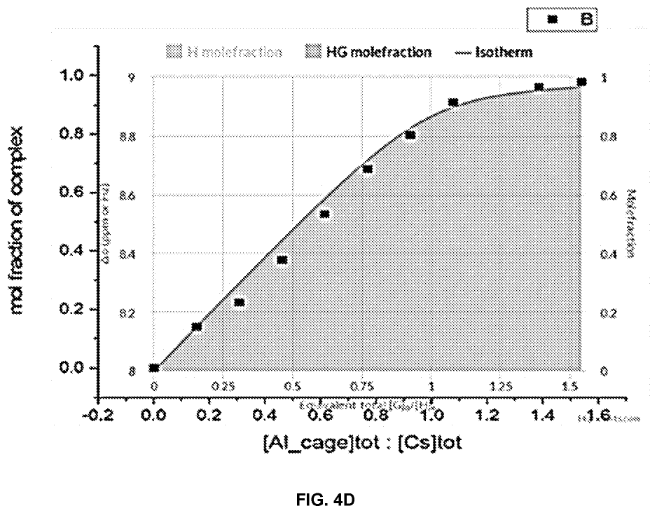

Guided by this finding, the binding interaction of AI-pdc-AA and CsClO₄ was studied via ¹H and ¹³³Cs NMR spectroscopy. The perchlorate salt was chosen as a model guest due to its solubility in DMSO. FIG. 4, panel a, represents the ¹H NMR spectra of varying concentrations of CsClO₄ at 298 K in the presence of 0.1 mM AI-pdc-AA in DMSO-d₆. Upon addition of CsClO₄, five new ¹H NMR resonances appear, while simultaneously the parent cage peaks decrease in intensity. These new features are comparable to that of the parent cage, as they occur in the same number and multiplicity with subtle changes to their chemical shifts. This observation suggests successful coordination of Cs⁺ to the cage, as the cation binding perturbs the local environment of the cage and changes the chemical shift of ¹H NMR resonances. Complete conversion occurred upon addition of 1 mol equivalent of CsClO₄, suggesting 1:1 host-guest binding (Cs⁺⊂AI-pdc-AA). However, higher binding ratios Cs⁺⊂2 AI-pdc-AA are observed at host concentrations higher than 1 mM (see Supporting Information for more details), consistent with previous reports of aggregation in coordination cages.

Further support on guest-host interactions was attained via ¹³³Cs NMR spectroscopy (FIG. 4, panel b)). Here, a ¹³³Cs signal at 74 ppm is observed in the absence of the host cage. Upon the addition of AI-pdc-AA, a gradual decrease of ¹³³Cs signal at 74 ppm is followed by the appearance of a new peak at 26 ppm, assigned to the bound cesium. Similar to ¹H NMR experiments, full conversion to the bound cesium signal occurred upon the addition of 1 mol equivalent of AI-pdc-AA further confirming 1:1 binding ratio.

Binding constants were then obtained from these NMR titration experiments. Specifically, ¹H and ¹³³Cs NMR spectra were used to obtain the molar ratios of bound and unbound species in solution. These ratios were then used to construct a binding isotherm in FIG. 4, panel d, and a binding constant for Cs⁺ coordination was extracted from the fit. The average result of three fittings indicates that the binding constant for the Cs⁺⊂AI-pdc-AA complex formation is ˜5000±100.

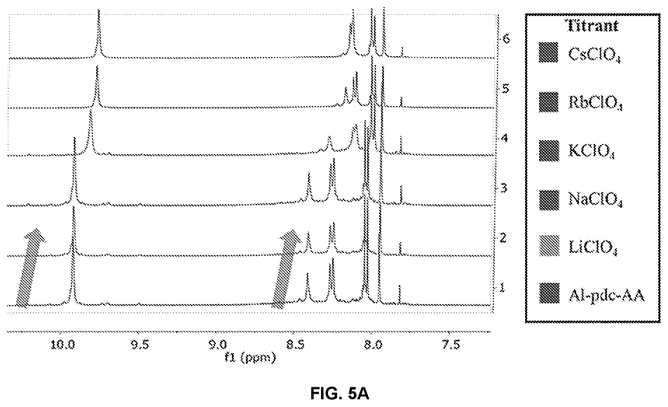

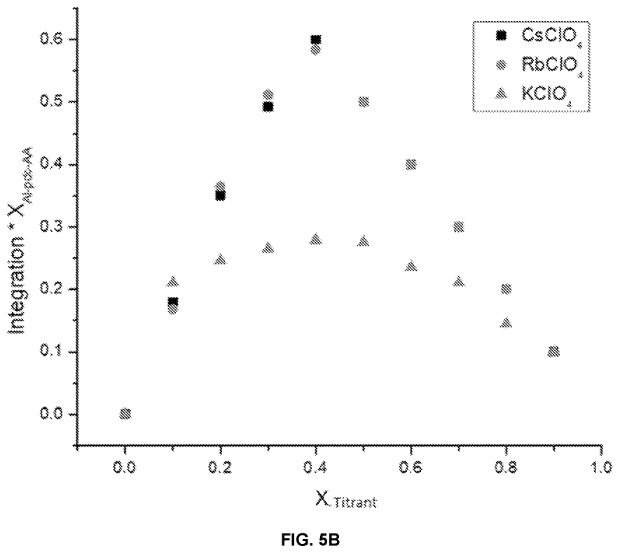

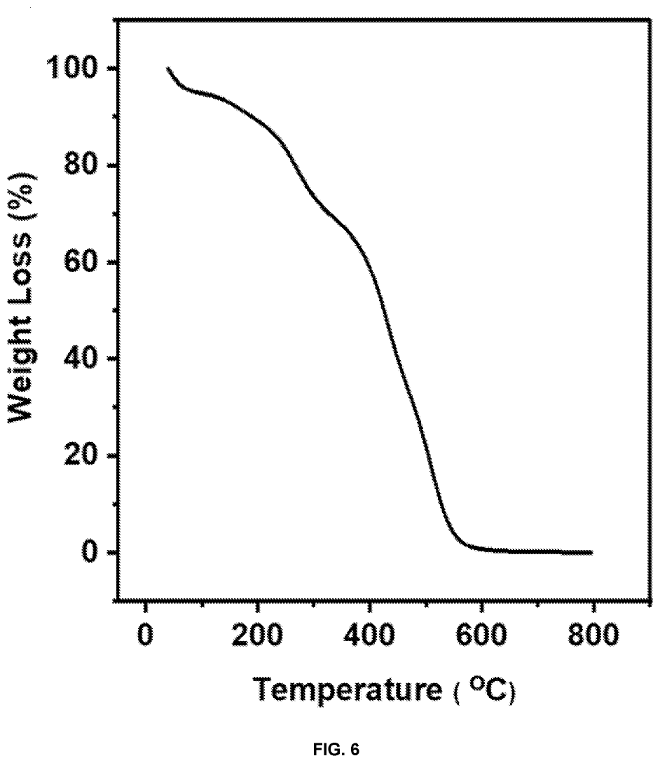

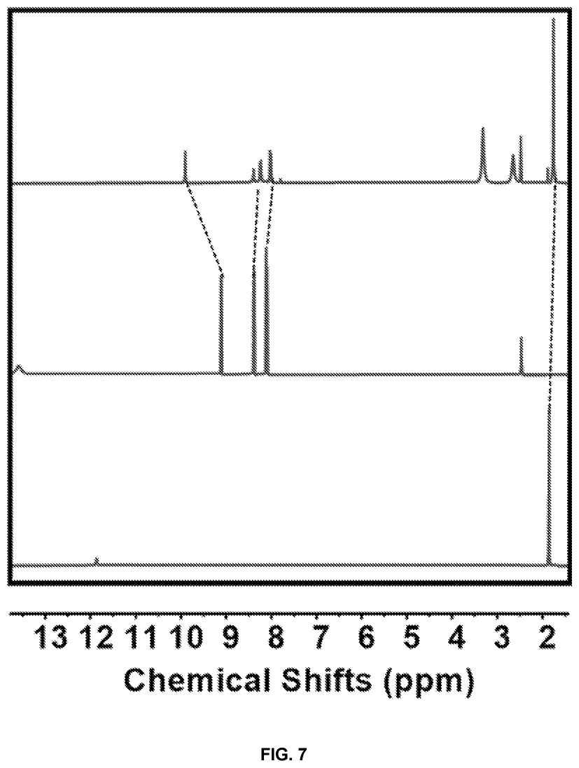

The ability of AI-pdc-AA to selectively bind cesium salts over other common alkali cations (Li⁺, Na⁺, K⁺ and Rb⁺) was probed using ¹H NMR spectroscopy. In doing so, we aimed to corroborate our hypothesis that the large ionic radius facilitates coordination and showcase the selectivity of AI-pdc-AA for large cations, especially as competitive cation encapsulation is expected in wastewater remediation. FIG. 5 shows the NMR spectra of AI-pdc-AA in DMSO-d₆ in the presence of 1 equivalent of LiClO₄, NaClO₄, KClO₄, RbClO₄ and CsClO₄. The addition of LiClO₄ and NaClO₄ to AI-pdc-AA results in no change to ¹H NMR spectral resonances and thereby shows that Li⁺ and Na⁺ likely do not bind to the cage and if they do, are very weakly bound. The addition of KClO₄ and RbClO₄, on the other hand, induced an upfield shift, albeit to different extents. A modest change in chemical shift (Δδ=0.097 ppm) observed with the addition of KClO₄ indicates AI-pdc-AA binds K⁺ with a lower binding constant. Conversely, RbClO₄ (ionic radius of Rb⁺ 1.66 Å) displayed chemical shifts intermediate to K⁺ and Cs⁺ (Δδ=0.138 ppm for Rb⁺ and Δδ=0.144 ppm for Cs⁺ between bound and unbound species), indicating comparable binding constants. These results showcase that ionic radius plays a key role in determining the binding affinity for these species.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. (canceled)

2. (canceled)

3. (canceled)

4. A method of making a metal-organic cage, the method comprising
(a) dissolving a salt of a main group metal, for example a halide, a sulfate, or a nitrate, of a main group metal, an organic ligand, and an organic acid in a solvent to form a mixture; and
(b) reacting the mixture for a period of time at an elevated temperature relative to room temperature;
(c) cooling or allowing the heated mixture to cool, wherein upon cooling the metal-organic cage is formed.

5. (canceled)

6. (canceled)

7. (canceled)

8. (canceled)

9. (canceled)

10. (canceled)

11. (canceled)

12. (canceled)

13. A self-assembled molecular cage comprising a first whole number of 6-coordinate metal atoms and a second whole number of a tridentate ligands, which self-assembled molecular cage defines a metal ion chelation volume;
wherein the 6-coordinate metal atom is selected from the group consisting of aluminum, titanium, and zirconium;
wherein the ligand is a compound of formula I: 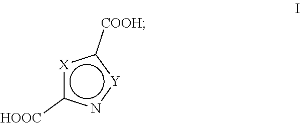
wherein X is —C(H)═N—, —C(H)═C(H)—, oxygen, or sulfur;
wherein Y is C—H or N; or salt thereof.

14. The self-assembled molecular cage of claim 13 wherein the metal is aluminum.

15. The self-assembled molecular cage of claim 13 wherein the ratio of the first whole number to the second whole number is 8:12.

16. The self-assembled molecular cage of claim 13 wherein the metal is titanium.

17. The self-assembled molecular cage of claim 13 wherein the metal is zirconium.

18. The self-assembled molecular cage of claim 13 comprising a third number of a carboxylic acids and/or anions thereof which acids and/or anions coordinate with one or more of the 6-coordinate metal atoms.

19. The self-assembled molecular cage of claim 13 wherein X is a C═C bond.

20. The self-assembled molecular cage of claim 13 wherein X is a sulfur atom.

21. The self-assembled molecular cage of claim 13 wherein X is a C═N.

22. The self-assembled molecular cage of claim 13 wherein Y is C—H.

23. The self-assembled molecular cage of claim 13 wherein Y is N.

24. The self-assembled molecular cage of claim 13 wherein the compound of formula I is selected from the group consisting of:

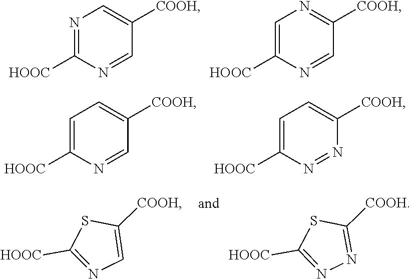

25. The self-assembled molecular cage of claim 13 wherein the metal ion is Cs⁺ or Rb⁺.

26. The self-assembled molecular cage of claim 13 wherein the metal ion is Cs⁺.

27. The self-assembled molecular cage of claim 13 wherein the carboxylic acid or anion thereof is a C1-C6 alkanoic acid or anion thereof.

28. The self-assembled molecular cage of claim 13 wherein the carboxylic acid or anion thereof is a C1-C3 alkanoic acid or anion thereof.

29. (canceled)

30. The self-assembled molecular cage of claim 13 wherein the compound of formula I is 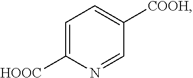 [SMILES: O=C(O)c1ccc(C(=O)O)nc1]
or a salt thereof.

31. (canceled)

32. (canceled)

33. The self-assembled molecular cage of claim 13 wherein the molecular formula of the cage is about C₇₂H₄₈Al₈N₈O₅₂ as determined from single crystal X-ray diffraction of a cell unit C₇₂H₄₈Al₈N₈O₅₂·11[C₃H₇NO] wherein C₃H₇NO is the empirical formula of N,N-dimethylformamide, and excluding any charge balancing H-atoms.

34. The self-assembled molecular cage of claim 13 wherein the molecular formula of the cage is about C₇₂H₄₈Al₈N₈O₅₂ as determined from single crystal X-ray diffraction of a cell unit C₇₂H₄₈Al₈N₈O₅₂·11[C₃H₇NO] associated with a cesium cation or a rubidium cation, and excluding any charge balancing H-atoms.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)
